(19) United States
(12) Patent Application Publication
(10) Pub. No.: US 2012/0183028 A1
(43) Pub. Date: Jul. 19, 2012

(54) APPARATUS AND METHOD FOR RANGING IN DISTRIBUTED ANTENNA SYSTEM

(75) Inventors: Shuangfeng HAN, Suwon-si (KR); Hyun-Jeong KANG, Seoul (KR); Su-Ryong JEONG, Yongin-si (KR)

(73) Assignee: SAMSUNG ELECTRONICS CO. LTD., Suwon-si (KR)

(21) Appl. No.: 13/351,400

(22) Filed: Jan. 17, 2012

(30) Foreign Application Priority Data
Jan. 18, 2011 (KR) 10-2011-0004833

(51) Int. Cl. H04B 7/00; H04B 1/38

(52) U.S. Cl. 375/222; 455/507; 455/509

(57) ABSTRACT

An apparatus and a method for ranging in a distributed antenna system are provided. A method for an operation of a Mobile Station (MS) in a distributed antenna system includes obtaining per-group ranging code configuration information indicating a ranging code allocation for each antenna port group, determining an antenna port group that the MS belongs to, and performing a ranging procedure by one of a plurality of ranging codes allocated to the antenna port group that the MS belongs to.

### PRIORITY

This application claims the benefit under 35 U.S.C. §119(a) of a Korean patent application filed in the Korean Intellectual Property Office on Jan. 18, 2011 and assigned Serial No. 10-2011-0004833, the entire disclosure of which is hereby incorporated by reference.

### BACKGROUND OF THE INVENTION

1. Field of the Invention

The present invention relates generally to a ranging procedure. More particularly, the present invention relates to an apparatus and method for ranging in a distributed antenna system.

2. Description of the Related Art:

In a wireless communication system, a Mobile Station (MS) accesses a wireless access providing entity such as a Base Station (BS) and obtains system information to perform communication. Detailed operations of the processes vary according to the standards adopted for the system. For example, the mobile station may use a signal such as a preamble to acquire downlink physical synchronization and obtain system information including access parameters.

A ranging process may be performed in the access process. In the ranging process, a time offset, a frequency offset, a power adjustment, and the like are determined so that the mobile station may transmit signals in synchronization with the base station. The ranging process is typically initiated by the transmission of a ranging code by the mobile station. To this end, the base station uses a downlink control message to provide ranging channel and ranging code configuration information to mobile stations. Mobile Stations (MSs) desiring to access the base station transmit a ranging code according to the information included in the downlink control message, and the base station adjusts the time offset and the like according to the ranging code reception state.

In a wireless communication system according to the related art, each base station covers one cell and controls the wireless access of all the mobile stations located in its own cell. Accordingly, the access processes including the ranging process are defined on the assumption that each base station covers one cell. However, recently, wireless communication systems capable of supporting an increasing data rate are needed, due to users' various service requests and service quality requirements. Accordingly, research and development is being conducted to provide wireless communication systems that have a variety of new structures evolving from the conventional structure in which each base station covers one cell. As result, a signaling process defined for the wireless communication systems of the related art may not be applied to wireless communication systems having new structures. What is therefore needed is a signaling process optimized for wireless communication systems having new structures, especially an initial access process such as a ranging process.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for ranging in a distributed antenna system.

Another aspect of the present invention is to provide an apparatus and method for allocating a ranging code in a distributed antenna system. Another aspect of the present invention is to provide an apparatus and method for grouping antenna ports in a distributed antenna system. Another aspect of the present invention is to provide an apparatus and method for determining an antenna port group including a mobile station in a distributed antenna system. Another aspect of the present invention is to provide an apparatus and method for selecting a ranging code for a mobile station in a distributed antenna system.

In accordance with an aspect of the present invention, a method for operation of a Mobile Station (MS) in a distributed antenna system is provided. The method includes obtaining per-group ranging code configuration information indicating a ranging code allocation for each antenna port group, determining an antenna port group that the mobile station belongs to, and performing a ranging procedure by one of a plurality of ranging codes allocated to the antenna port group that the mobile station belongs to.

In accordance with another aspect of the present invention, a method for operation of a Base Station (BS) in a distributed antenna system is provided. The method includes transmitting per-group ranging code configuration information indicating a ranging code allocation for each antenna port group, and detecting a ranging code received from a Mobile Station (MS).

In accordance with another aspect of the present invention, an apparatus for a Mobile Station (MS) in a distributed antenna system is provided. The apparatus includes a modem for receiving per-group ranging code configuration information indicating a ranging code allocation for each antenna port group, and a control unit for determining an antenna port group that the mobile station belongs to, and for performing a ranging procedure by one of a plurality of ranging codes allocated to the antenna port group that the mobile station belongs to.

In accordance with another aspect of the present invention, an apparatus for a Base Station (BS) in a distributed antenna system is provided. The apparatus includes a modem for transmitting per-group ranging code configuration information indicating a ranging code allocation for each antenna port group of the base station, and a control unit for detecting a ranging code received from a Mobile Station (MS).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a diagram illustrating a schematic configuration of a distributed antenna system according to an exemplary embodiment of the present invention;

FIG. 2 is a diagram illustrating an example of antenna port group partition in a distributed antenna system according to an exemplary embodiment of the present invention;

FIG. 3 is a diagram illustrating an example of ranging code allocation in a distributed antenna system according to an exemplary embodiment of the present invention;

FIG. 4 is a flow diagram illustrating a process for operation of a Mobile Station (MS) in a distributed antenna system according to an exemplary embodiment of the present invention;

FIG. 5 is a flow diagram illustrating a process for operation of a Base Station (BS) in a distributed antenna system according to an exemplary embodiment of the present invention;

FIG. 6 is a block diagram of a Mobile Station (MS) in a distributed antenna system according to an exemplary embodiment of the present invention; and

FIG. 7 is a block diagram of a Base Station (BS) in a distributed antenna system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention relate to an apparatus and method for performing efficient ranging in a distributed antenna system by suitably allocating a ranging code. Exemplary embodiments of the present invention provide a scheme for ranging in a distributed antenna system. For the convenience of description, exemplary embodiments of the present invention are described using terms defined in the IEEE 802.16, 3GPP LTE standards. However, exemplary embodiments of the present invention are not limited by the use of these terms, and may also be applicable to any other communication systems according to other standards.

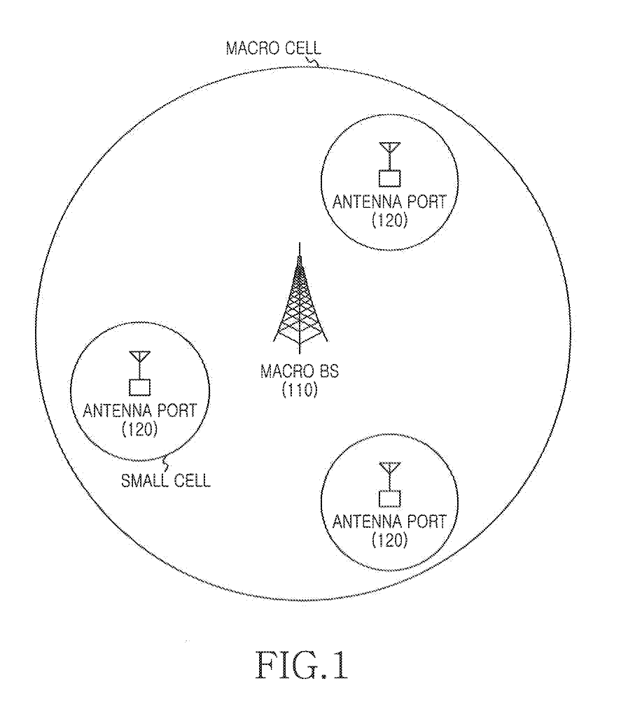

FIG. 1 is a diagram illustrating a schematic configuration of a distributed antenna system according to an exemplary embodiment of the present invention.

Referring to FIG. 1, a macro Base Station (BS) 110 is located in a macro cell. The macro BS 110 includes a plurality of antenna ports 120 that are installed at different locations in the macro cell. Each of the antenna ports 120 is controlled by the macro BS 110, and does not operate as a separate entity. Under the control of the macro BS 110, each of the antenna ports 120 communicates with Mobile Stations (MSs) located in a predetermined range. The predetermined range may be referred to as a hot spot area, a small cell, or the like. The antenna ports 120 may communicate different signals simultaneously. Through the configuration illustrated in FIG. 1, the system may provide an excellent channel quality throughout the entire cell. Although FIG. 1 illustrates that one antenna is connected to each of the antenna ports 120, a plurality of antennas may be connected to each of the antenna ports 120 according to exemplary embodiments of the present invention.

Ranging codes are designed to minimize the interference between codes. The interference between cells may be minimized through a solution that uses frequency resources or time slots in a non-overlapping manner. Because the system according to an exemplary embodiment of the present invention includes a plurality of small cells managed by antenna ports in the macro cell, a ranging code configuration of each antenna port (i.e., which antenna port is allocated a ranging code and which ranging code is allocated to an antenna port) may act as a main factor.

According to an exemplary embodiment of the present invention, all of the antenna ports included in a macro cell may use the same ranging code configuration. In this case, a ranging procedure through each antenna port may be performed using the same wireless resource. According to another exemplary embodiment of the present invention, all of the antenna ports included in a macro cell may use different ranging code configurations. The ranging code configurations of the respective antenna ports may be different from each other.

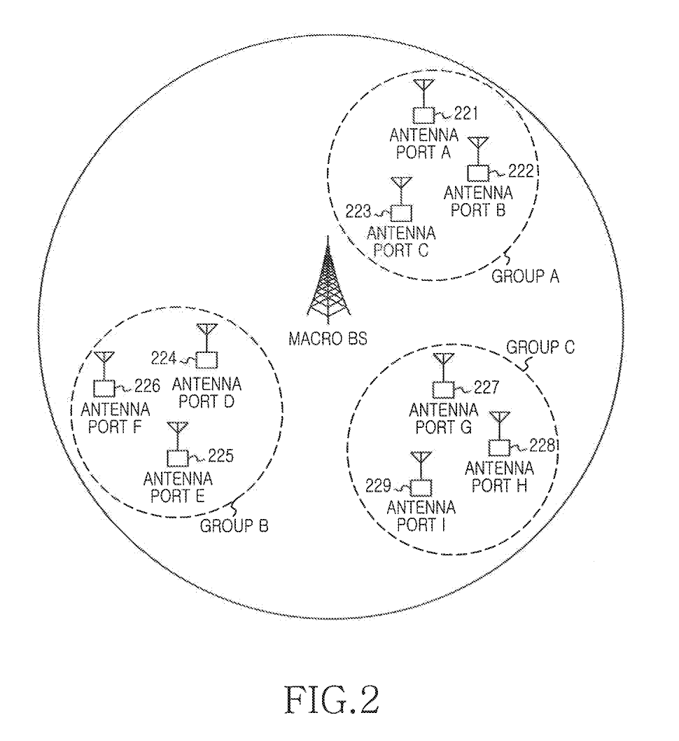

According to another exemplary embodiment of the present invention, the antenna ports included in each macro cell may be partitioned into a plurality of groups, and ranging code configurations where ranging codes are partitioned into the plurality of groups may be employed. The group may be determined according to the connectivity and the geographical location of an antenna port. For example, the group may be defined as illustrated in FIG. 2.

FIG. 2 is a diagram illustrating an example of antenna port group partition in a distributed antenna system according to an exemplary embodiment of the present invention.

Referring to FIG. 2, an antenna port A 221, an antenna port B 222, and an antenna port C 223 are included in a group A; an antenna port D 224, an antenna port E 225, and an antenna port F 226 are included in a group B; and an antenna port G 227, an antenna port H 228, and an antenna port I 229 are included in a group C. The same ranging code configuration is applied to at least one antenna port included in the same group. The antenna port A 221, the antenna port B 222, and the antenna port C 223 included in the group A use the same ranging code configuration. For interference mitigation, adjacent groups receive a ranging code through different frequency resources or different time slots.

Information indicating a per-group ranging code configuration (hereinafter referred to as per-group ranging code configuration information) may be broadcasted through a macro BS or each antenna port. For example, the per-group ranging code configuration information may be transmitted through a message such as a super frame header or a System Information Block (SIB). Accordingly, a mobile station detects the group including an antenna port to be connected, and performs a ranging procedure according to the corresponding ranging code configuration. The mobile station may use a downlink signal of each antenna port to determine which group includes the mobile station. Antenna ports use different identifiers and transmit different downlink reference signals. Accordingly, the mobile station uses a received downlink reference signal of an antenna port to measure a receive (RX) power value of the antenna port, and uses the RX power value to determine which group's ranging code configuration it is to use.

For example, the group determination based on the RX power value may be performed as follows. The mobile station may use a first threshold value for determining that the mobile station belongs to the corresponding group, or a second threshold value for determining that the mobile station is not included in the corresponding group. When only an RX power value of at least one antenna port included in the same group is measured, the mobile station may determine that the mobile station belongs to the corresponding group when the RX power measurement value is greater than the first threshold value. When RX power values of two antenna ports included in different groups are measured, the mobile station may determine that the mobile station belongs to the first group when the RX power measurement value of the antenna port included in the first group is greater than the first threshold value and the RX power measurement value of the antenna port included in the second group is smaller than the second threshold value. When the RX power measurement value of the antenna port included in the first group is greater than the first threshold value and the RX power measurement value of the antenna port included in the second group is greater than the second threshold value, the mobile station may determine that the mobile station is located at the boundary between the first group and the second group. The RX power value may be replaced with another channel quality indication index such as a Signal-to-Noise Ratio (SNR) or a Signal-to-Interference plus Noise Ratio (SINR).

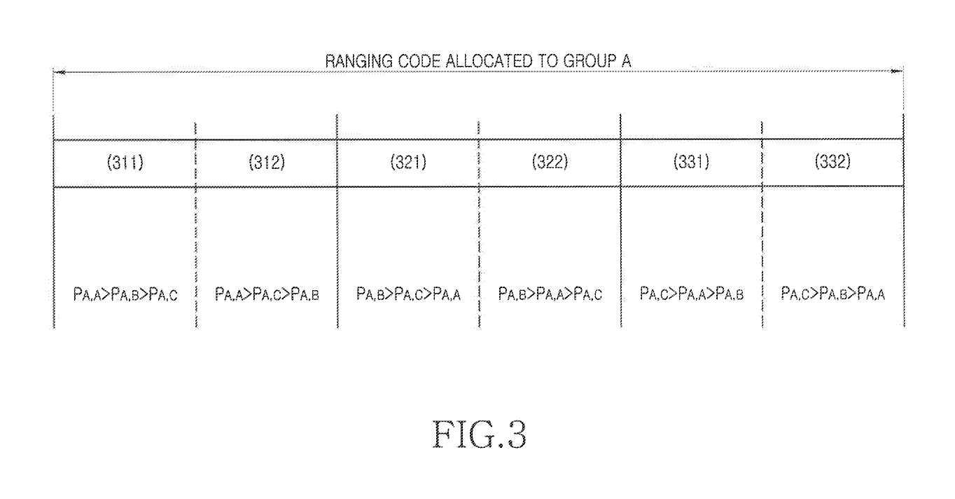

When three groups are determined for the group A illustrated in FIG. 2, a ranging code allocation to the antenna ports included in the group A may be performed as illustrated in FIG. 3.

FIG. 3 is a diagram illustrating an example of ranging code allocation in a distributed antenna system according to an exemplary embodiment of the present invention. FIG. 3 illustrates ranging codes allocated to the group A. FIG. 3 illustrates a range of ranging code indexes, and represents an arrangement of ranging code indexes.

Referring to FIG. 3, a mobile station selects a ranging code according to the RX power strength of the antenna ports included in the group A, among the ranging codes allocated to the group A. The ranging codes are distributed into ranges 311, 312, 321, 322, 331, and 332. Each antenna port has a pre-partitioned ranging code among the ranging codes allocated to the corresponding group. For example, when the RX power strength is such that an antenna port A P_{A,A}>an antenna port B P_{A,B}>an antenna port C P_{A,C}, the mobile station transmits a ranging code included in a first range 311. When the RX power strength is such that an antenna port B P_{A,B}>an antenna port A P_{A,A}>an antenna port C P_{A,C}, the mobile station transmits a ranging code included in a second range 322. The mobile station may transmit a ranging code included in the ranges 312, 321, 331, and 332 according to the conditions illustrated in FIG. 3. If four or more antenna ports are included in the group, the ranging codes may be partitioned into a larger number of ranges.

When the mobile station is located at the boundary between the groups, it may be difficult for the mobile station to determine which group's ranging code configuration it is to use. Accordingly, a base station may define a dedicated ranging code configuration for the case of the mobile station being located at the boundary between the groups (hereinafter referred to as a boundary-dedicated ranging code configuration). In this case, the base station may transmit the boundary-dedicated ranging code configuration, and the mobile station located at the boundary may perform a ranging procedure according to the boundary-dedicated ranging code configuration.

Hereinafter, with reference to the accompanying drawings, a detailed description will be given of the operations and configurations of a mobile station and a base station that perform a ranging process as described above.

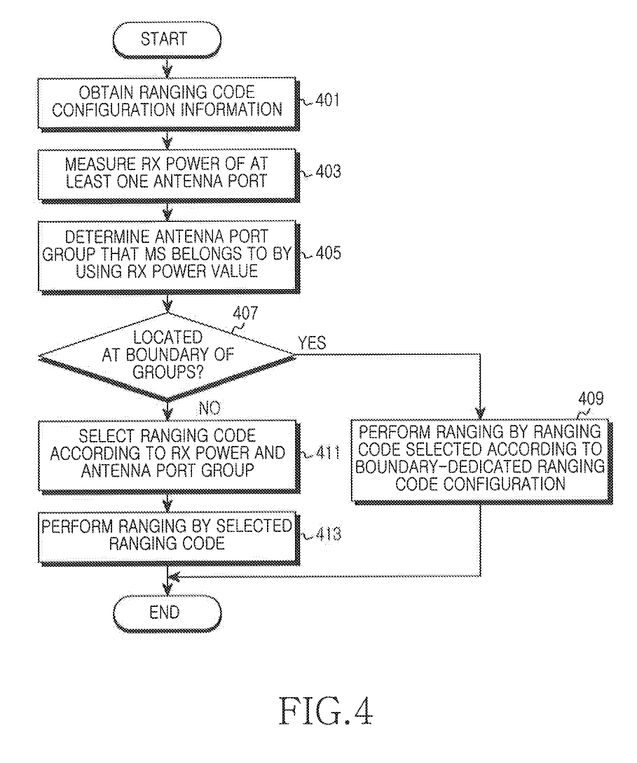

FIG. 4 is a flow diagram illustrating a process for operation of a Mobile Station (MS) in a distributed antenna system according to an exemplary embodiment of the present invention.

Referring to FIG. 4, the mobile station obtains ranging code configuration information in step 401. The ranging code configuration information may include per-group ranging code configuration information that indicates a ranging code allocation for each antenna port group. The ranging code configuration information may include ranging channel resource allocation information of each antenna port group, that is, information indicating which frequency resource or time slot is allocated to each antenna port group. The ranging code configuration information may be broadcasted through the base station or each antenna port. For example, the ranging code configuration information may be broadcasted through a message such as a super frame header or a System Information Block (SIB). Although not illustrated in FIG. 4, the mobile station may detect a reference signal to acquire synchronization, before obtaining the ranging code configuration information.

In step 403, the mobile station measures an RX power value of at least one adjacent antenna port. Each antenna port transmits a downlink reference signal discriminated from that of another antenna port. Accordingly, the mobile station may identify an adjacent antenna port by the downlink reference signal, and may also measure a RX power value of the corresponding antenna port by the downlink reference signal.

In step 405, the mobile station uses the RX power measurement value to determine which antenna port group includes the mobile station. The mobile station may compare the RX power measurement value with at least one predetermined threshold value to determine an antenna port group that the mobile station belongs to. For example, the mobile station may use a first threshold value for determining that the mobile station belongs to the corresponding group, or a second threshold value for determining that the mobile station is not included in the corresponding group.

When only an RX power value of at least one antenna port included in the same group is measured, the mobile station may determine that the mobile station belongs to the corresponding group when the RX power measurement value is greater than the first threshold value. When only RX power values of antenna ports included in different groups are measured, the mobile station may determine that the mobile station belongs to the first group when the RX power measurement value of the antenna port included in the first group is greater than the first threshold value, and when the RX power measurement value of the antenna port included in the remaining groups is smaller than the second threshold value. When the RX power measurement value of the antenna port included in the first group is greater than the first threshold value and the RX power measurement value of the antenna port included in the remaining groups is greater than the second threshold value, the mobile station may determine that the mobile station is located at the boundary between the first group and the second group.

In step 407, the mobile station determines whether the mobile station is located at the boundary between the groups. The mobile station determines whether the mobile station has been determined to be located at the boundary between the groups as a result of the determination in step 405. If the mobile station is located at the boundary between the groups, the mobile performs a ranging procedure by a ranging code in step 409. The ranging code is selected according to a dedicated ranging code configuration for the case of the mobile station being located at the boundary between the groups (hereinafter referred to as a boundary-dedicated ranging code configuration). The boundary-dedicated ranging code configuration may be broadcasted through a base station. For example, the boundary-dedicated ranging code configuration may be obtained in step 401 together with the per-group ranging code configuration information.

If the mobile station is located at the boundary between the groups (i.e., if the mobile station belongs to a specific group), the mobile station selects a ranging code in step 411 according to a corresponding antenna port group and the RX power measurement value of the antenna port included in the group. The mobile station may use the per-group ranging code configuration information received in step 401 to detect a range of ranging code indexes allocated to each group. A selection range is partitioned according to an RX power order of antenna ports included in the corresponding group, in the ranging codes allocated to each group. The mobile station may also detect the partition information according to the RX power order from the per-group ranging code configuration information. The mobile station detects a selection range according to the RX power order of the antenna ports included in the group including the mobile station, and selects a ranging code within the selection range. The mobile station detects a selection range corresponding to an RX power order of antenna ports included in the antenna port group including the mobile station, within an entire range of ranging codes allocated to the group, and selects a ranging code within the selection range.

In step 413, the mobile station performs a ranging procedure by the selected ranging code. The mobile station generates a ranging signal by a sequence of the selected ranging code, and transmits the ranging signal through the ranging channel resource allocated to the group including the mobile station. Thereafter, the mobile station may communicate at least one ranging process control message with the base station.

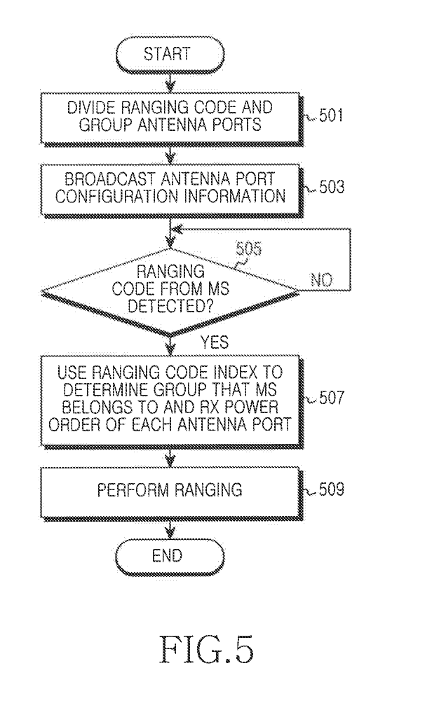

FIG. 5 is a flow diagram illustrating a process for operation of a Base Station (BS) in a distributed antenna system according to an exemplary embodiment of the present invention.

Referring to FIG. 5, in step 501, the base station divides ranging codes and groups antenna ports that are installed in a distributed manner. The base station divides the antenna ports into a plurality of groups according to the connectivity and the geographical location of each antenna port. The base station divides all the ranging codes and allocates the ranging codes to each group. According to another exemplary embodiment of the present invention, the operation of step 501 may be performed not by the base station but by a service provider or a system operator. In this case, the operation of step 501 is omitted, and the base station uses the group division result and the ranging code allocation result that are inputted by the system operator.

In step 503, the base station broadcasts ranging code configuration information. The ranging code configuration information may include per-group ranging code configuration information that indicates a ranging code allocation for each antenna port group. The ranging code configuration information may include ranging channel resource allocation information of each antenna port group, i.e., information indicating which frequency resource or time slot is allocated to each antenna port group. The ranging code configuration information may be broadcasted through the base station or each antenna port. The base station may directly transmit the ranging code configuration information, or may transmit the ranging code configuration information through each antenna port by controlling the antenna ports that are installed in a distributed manner. For example, the ranging code configuration information may be broadcasted through a message such as a super frame header or a System Information Block (SIB).

In step 505, the base station determines whether a ranging code transmitted by a mobile station is detected. The ranging code is one of predetermined sequences. The base station may determine which sequence has been transmitted, through the correlation between sequence candidates, i.e., effective ranging codes, and a signal received through a ranging channel.

If the ranging code is detected, the base station determines an antenna port group that the mobile station belongs to in step 507, and also determines a RX power order of each antenna port measured by the mobile station. In step 509, the base station performs a ranging process with the mobile station. For example, the base station may transmit at least one control message for the ranging process with the mobile station. The operation of step 509 may be omitted in another exemplary embodiment of the present invention.

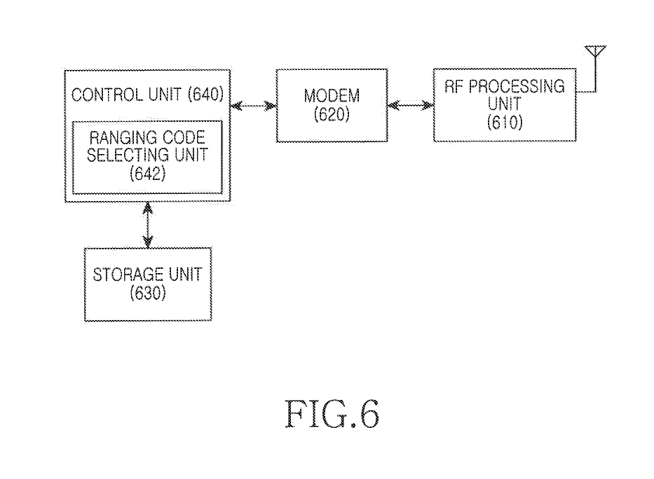

FIG. 6 is a block diagram of a Mobile Station (MS) in a distributed antenna system according to an exemplary embodiment of the present invention.

Referring to FIG. 6, the mobile station may include a Radio Frequency (RF) processing unit 610, a modem 620, a storage unit 630, and a control unit 640. The MS may also include other units not shown here for purposes of convenience, such as an input unit or a display unit. Similarly, the functionality of two or more of the above units may be integrated into a single component. Various units may be implemented in hardware, in software, or as a combination thereof according to design. However, it would be understood that at least some of the above units would require a hardware component in order to carry out their functions.

The RF processing unit 610 performs functions (e.g., signal band conversion and amplification) for communicating signals through a wireless channel. The RF processing unit 610 up-converts a baseband signal received from the modem 620 into an RF signal, and transmits the RF signal through an antenna. The RF processing unit 610 down-converts a RF signal received through the antenna into a baseband signal. For example, the RF processing unit 610 may include an amplifier, a mixer, an oscillator, a Digital-to-Analog Converter (DAC), and an Analog-to-Digital Converter (ADC).

The modem 620 performs conversion between a baseband signal and a bit string according to the physical layer standard of the system. For example, according to an Orthogonal Frequency Division Multiplexing (OFDM) scheme, in a data transmission (TX) mode, the modem 620 encodes/modulates a TX bit string to generate complex symbols, maps the complex symbols to subcarriers, and generates OFDM symbols by an Inverse Fast Fourier Transform (IFFT) operation and a Cyclic Prefix (CP) insertion. In a data reception (RX) mode, the modem 620 divides a baseband signal, received from the RF processing unit 610, into OFDM symbols, restores signals mapped to subcarriers by a Fast Fourier Transform (FFT) operation, and restores an RX bit string by demodulation and decoding. The modem 620 detects a reference signal transmitted through a base station or an antenna port.

The storage unit 630 stores data such as user contents, applications, and a basic program for operation of the mobile station. The storage unit 630 provides the stored data at the request of the control unit 640. The storage unit 630 stores sequence values of ranging codes. The storage unit 630 stores ranging code configuration information received from a base station.

The control unit 640 controls overall operations of the mobile station. For example, the control unit 640 generates TX traffic packets and control messages and provides the same to the modem 620. The control unit 640 interprets RX traffic packets and control messages received from the modem 620. According to an exemplary embodiment of the present invention, the control unit 640 controls functions of obtaining ranging code configuration information and selecting a ranging code according to the antenna port group that the mobile station belongs to. For example, the control unit 640 controls the mobile station to operate according to the process illustrated in FIG. 4.

The operations of the control unit 640 for obtaining the ranging code configuration information obtainment and the ranging code selection will be described below in detail. Through a broadcast message received through the RF processing unit 610 and the modem 620, the control unit 610 obtains the ranging code configuration information including per-group ranging code configuration information that indicates a ranging code allocation for each antenna port group. The ranging code configuration information may be broadcasted through a base station or each antenna port. The control unit 640 measures an RX power value of at least one adjacent antenna port by using a downlink reference signal of antenna ports detected by the modem 620, and determines which antenna port group includes the mobile station, by using the measured RX power value.

If the mobile station is located at the boundary between the groups, the control unit 640 selects a ranging code according to a boundary-dedicated ranging code configuration and performs a ranging procedure by the selected ranging code. If the mobile station is not located at the boundary between the groups, a ranging code selecting unit 642 of the control unit 640 selects a ranging code according to the corresponding antenna port group and the measured RX power value of the antenna port included in the group. The ranging code selecting unit 642 detects a selection range according to the RX power order of the antenna ports included in the group including the mobile station, and selects a ranging code within the selection range. The control unit 640 then performs a ranging process.

In the above operation of the control unit 640, the determination of the antenna port group that the mobile station belongs to may be performed as follows. For example, when only an RX power value of at least one antenna port included in the same group is measured, the control unit 640 may determine that the mobile station belongs to the corresponding group when the RX power measurement value is greater than the first threshold value. When only RX power values of antenna ports included in different groups are measured, the control unit 640 may determine that the mobile station belongs to the first group when the RX power measurement value of the antenna port included in the first group is greater than the first threshold value and the RX power measurement value of the antenna port included in the remaining groups is smaller than the second threshold value. When the RX power measurement value of the antenna port included in the first group is greater than the first threshold value, and the RX power measurement value of the antenna port included in the remaining groups is greater than the second threshold value, the control unit 640 may determine that the mobile station is located at the boundary between the first group and the second group.

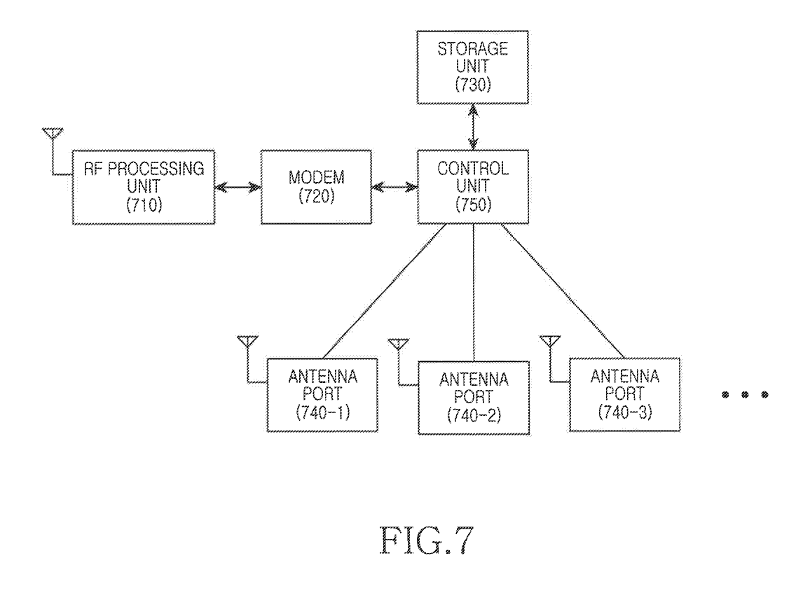

FIG. 7 is a block diagram of a Base Station (BS) in a distributed antenna system according to an exemplary embodiment of the present invention.

Referring to FIG. 7, the base station may include a Radio Frequency (RF) processing unit 710, a modem 720, a storage unit 730, a plurality of antenna ports 740-1 to 740-3, and a control unit 750. While three antenna ports are shown in FIG. 7, it would be understood that fewer or greater than three antenna ports may be included in the base station.

The RF processing unit 710 performs functions (e.g., signal band conversion and amplification) for communicating signals through a wireless channel. That is, the RF processing unit 710 up-converts a baseband signal, received from the modem 720, into an RF signal, and transmits the RF signal through an antenna. The RF processing unit 710 down-converts a RF signal, received through the antenna, into a baseband signal. For example, the RF processing unit 710 may include an amplifier, a mixer, an oscillator, a Digital-to-Analog Converter (DAC), and an Analog-to-Digital Converter (ADC).

The modem 720 performs conversion between a baseband signal and a bit string according to the physical layer standard of the system. For example, according to an Orthogonal Frequency Division Multiplexing (OFDM) scheme, in a data transmission (TX) mode, the modem 720 encodes/modulates a TX bit string to generate complex symbols, maps the complex symbols to subcarriers, and generates OFDM symbols by an Inverse Fast Fourier Transform (IFFT) operation and a Cyclic Prefix (CP) insertion. In a data reception (RX) mode, the modem 720 divides a baseband signal, received from the RF processing unit 710, into OFDM symbols, restores signals mapped to subcarriers by a Fast Fourier Transform (FFT) operation, and restores an RX bit string by demodulation and decoding. The modem 720 also detects a ranging code transmitted by a mobile station.

The storage unit 730 stores data such as user traffic and a basic program for operation of the base station. The storage unit 730 provides the stored data at the request of the control unit 750. The storage unit 730 stores sequence values of ranging codes. The storage unit 730 stores ranging code configuration information to be broadcasted to mobile stations.

The antenna ports 740-1 to 740-3 are spaced apart from the body of the base station, and are installed in a cell in a distributed manner. The antenna ports 740-1 to 740-3 transmit TX data received from the control unit 750, and provide received data to the control unit 750. The antenna ports 740-1 to 740-3 may have the same configuration as the RF processing unit 710, or may have the same configuration as the RF processing unit 710 and the modem 720. When the antenna ports 740-1 to 740-3 have the same configuration as the RF processing unit 710, the antenna ports 740-1 to 740-3 may receive TX data from the modem 720 unlike the illustration of FIG. 7.

The control unit 750 controls an overall operation of the base station. For example, the control unit 750 generates TX traffic packets and control messages and provides the same to the modem 720. The control unit 750 interprets RX traffic packets and control messages received from the modem 720. The control unit 750 provides TX data to the antenna ports 740-1 to 740-3. According to an exemplary embodiment of the present invention, the control unit 750 controls functions of transmitting ranging code configuration information including information about ranging codes allocated according to the present invention. For example, the control unit 750 controls the base station to operate according to the process illustrated in FIG. 5.

The operation of the control unit 750 for the ranging code configuration information transmission will be described below in detail. The control unit 750 generates ranging code configuration information including at least one of ranging channel resource allocation information and per-group ranging code configuration information indicating a ranging code allocation for each antenna port group, and broadcasts the ranging code configuration information. The ranging code configuration information may be broadcasted through a base station or each antenna port. When the ranging code configuration information is transmitted through the base station, the control unit 750 outputs the ranging code configuration information to the modem 720. When the ranging code configuration information is transmitted through each of the antenna ports, the control unit 750 outputs the ranging code configuration information to the antenna ports 740-1 to 740-3.

When the ranging code transmitted by a mobile station is detected by the modem 720, the control unit 750 may use the ranging code index to determine an antenna port group that the mobile station belongs to and determine an RX power order of each antenna port measured by the mobile station. The control unit 750 then performs a ranging process with the mobile station.

As described above, exemplary embodiments of the present invention group antenna ports in a distributed antenna system and apply different ranging code configurations to the respective groups, thereby making it possible to perform a ranging process optimized for the distributed antenna system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for an operation of a Mobile Station (MS) in a distributed antenna system, the method comprising:
obtaining per-group ranging code configuration information indicating a ranging code allocation for each antenna port group;
determining an antenna port group that the MS belongs to; and
performing a ranging procedure by one of a plurality of ranging codes allocated to the antenna port group that the MS belongs to.

2. The method of claim 1, further comprising:
obtaining the ranging channel resource allocation information of each antenna port group.

3. The method of claim 1, wherein the per-group ranging code configuration information is transmitted through one of a Base Station (BS) and each antenna port.

4. The method of claim 1, wherein the determining of the antenna port group that the MS belongs to comprises:
measuring a receive (RX) power value of at least one antenna port; and
determining the antenna port group that the MS belongs to based on the RX power measurement value.

5. The method of claim 4, wherein the determining of the antenna port group that the MS belongs to comprises:
when only an RX power value of at least one antenna port included in the same group is measured, if the RX power measurement value is greater than a first threshold value, determining that the MS belongs to the corresponding group.

6. The method of claim 4, wherein the determining of the antenna port group that the MS belongs to comprises:
when only RX power values of antenna ports included in different groups are measured, if the RX power measurement value of the antenna port included in a first group is greater than a first threshold value and the RX power measurement value of the antenna port included in the remaining groups is smaller than a second threshold value, determining that the MS belongs to the first group.

7. The method of claim 4, wherein the determining of the antenna port group that the MS belongs to comprises:
when only RX power values of antenna ports included in different groups are measured, if the RX power measurement value of the antenna port included in a first group is greater than a first threshold value and the RX power measurement value of the antenna port included in the remaining groups is greater than a second threshold value, determining that the MS is located at a boundary between the first group and a second group.

8. The method of claim 1, wherein the performing of the ranging procedure comprises,
selecting a ranging code according to the antenna port group that the MS belongs to and an RX power measurement value of at least one antenna port included in the group.

9. The method of claim 8, wherein the selecting of the ranging code comprises,
detecting a selection range corresponding to an RX power order of antenna ports included in the antenna port group including the MS, within an entire range of the plurality of ranging codes allocated to the group; and
selecting a ranging code within the selection range.

10. The method of claim 1, wherein the performing of the ranging procedure comprises:
when the MS is located at a boundary between antenna port groups, selecting a ranging code according to a dedicated ranging code configuration for the case of the MS being located at the boundary.

11. A method for an operation of a Base Station (BS) in a distributed antenna system, the method comprising:
transmitting per-group ranging code configuration information indicating a ranging code allocation for each antenna port group; and
detecting a ranging code received from a Mobile Station (MS).

12. The method of claim 11, further comprising:
transmitting the ranging channel resource allocation information of each antenna port group.

13. The method of claim 11, wherein the per-group ranging code configuration information is transmitted through the BS or each antenna port.

14. The method of claim 11, further comprising:
grouping antenna ports installed in a distributed manner; and
allocating a plurality of ranging codes to the respective groups in a distributed manner.

15. The method of claim 11, further comprising:
determining an antenna port group that the MS belongs to based on an index of the detected ranging code.

16. The method of claim 11, further comprising:
determining a receive (RX) power order of each antenna port measured by the MS based on an index of the detected ranging code.

17. An apparatus for a Mobile Station (MS) in a distributed antenna system, the apparatus comprising:
a modem for receiving per-group ranging code configuration information indicating a ranging code allocation for each antenna port group; and
a control unit for determining an antenna port group that the MS belongs to, and for performing a ranging procedure by one of a plurality of ranging codes allocated to the antenna port group that the MS belongs to.

18. The apparatus of claim 17, wherein the modem receives the ranging channel resource allocation information of each antenna port group.

19. The apparatus of claim 17, wherein the per-group ranging code configuration information is transmitted through a Base Station (BS) or each antenna port.

20. The apparatus of claim 17, wherein the control unit measures a receive (RX) power value of at least one antenna port, and determines the antenna port group that the MS belongs to based on the RX power measurement value.

21. The apparatus of claim 20, wherein when only an RX power value of at least one antenna port included in the same group is measured, if the RX power measurement value is greater than a first threshold value, the control unit determines that the MS belongs to the corresponding group.

22. The apparatus of claim 20, wherein when only RX power values of antenna ports included in different groups are measured, if the RX power measurement value of the antenna port included in a first group is greater than a first threshold value and the RX power measurement value of the antenna port included in the remaining groups is smaller than a second threshold value, the control unit determines that the MS belongs to the first group.

23. The apparatus of claim 20, wherein when only RX power values of antenna ports included in different groups are measured, if the RX power measurement value of the antenna port included in a first group is greater than a first threshold value and the RX power measurement value of the antenna port included in the remaining groups is greater than a second threshold value, the control unit determines that the MS is located at a boundary between the first group and a second group.

24. The apparatus of claim 17, wherein the control unit selects a ranging code according to an antenna port group that the MS belongs to and an RX power measurement value of at least one antenna port included in the group.

25. The apparatus of claim 24, wherein the control unit detects a selection range corresponding to an RX power order of antenna ports included in the antenna port group including the MS, within an entire range of the plurality of ranging codes allocated to the group, and selects a ranging code within the selection range.

26. The apparatus of claim 17, wherein when the MS is located at a boundary between antenna port groups, the control unit selects a ranging code according to a dedicated ranging code configuration for the case of the MS being located at the boundary.

27. An apparatus for a Base Station (BS) in a distributed antenna system, the apparatus comprising:
a modem for transmitting per-group ranging code configuration information indicating a ranging code allocation for each antenna port group of the BS; and
a control unit for detecting a ranging code received from a Mobile Station (MS).

28. The apparatus of claim 27, wherein the apparatus transmits the ranging channel resource allocation information of each antenna port group.

29. The apparatus of claim 27, wherein the per-group ranging code configuration information is transmitted through the BS or each antenna port.

30. The apparatus of claim 27, wherein the control unit groups antenna ports installed in a distributed manner, and allocates a plurality of ranging codes to the respective groups in a distributed manner.

31. The apparatus of claim 27, wherein the control unit determines an antenna port group that the MS belongs to based on an index of the detected ranging code.

32. The apparatus of claim 27, wherein the control unit determines a receive (RX) power order of each antenna port measured by the MS based on an index of the detected ranging code.
